(19) United States
(12) Patent Application Publication
(10) Pub. No.: US 2009/0019268 A1
(43) Pub. Date: Jan. 15, 2009

(54) PROCESSOR

(75) Inventors: Hidenori Matsuzaki, Kawasaki-shi (JP); Manabu Mukai, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/053,023

(22) Filed: Mar. 21, 2008

(30) Foreign Application Priority Data
Jul. 12, 2007 (JP) 2007-183335

(51) Int. Cl. G06F 9/44

(52) U.S. Cl. 712/221; 712/225

(57) ABSTRACT

The processor includes: a plurality of functional bocks that are respectively synchronized and operates to perform a process according to a control signal; a connection unit that is changeable to a smaller bandwidth than a bandwidth of inputs/outputs of the respective functional blocks and is connected between the respective functional blocks; a first data converter that switches a bandwidth of the connection unit; a second data converter that switches a data transmission rate of input/output data of the respective functional blocks; and a controller that controls the first data converter and the second data converter.

### RELATED APPLICATION(S)

The present disclosure relates to the subject matters contained in Japanese Patent Application No. 2007-183335 filed on Jul. 12, 2007, which is incorporated herein by reference in its entirety.

### FIELD

The present invention relates to a processor having a plurality of functional blocks.

### BACKGROUND

In recent years, a processor is attracting attention, which has a plurality of functional blocks including an arithmetic device, a register, a memory, and the like, mutually transmits and receives data between these functional blocks, and performs an arithmetic process.

The processor may provide a high arithmetic processing performance at low power consumption by evenly assigning processes to the respective functional blocks, but requires control information for controlling the arithmetic processes in the respective functional blocks.

A technique has been disclosed which automatically generates control information for controlling arithmetic processes in the respective functional blocks by a complier from a program described in C programming language. An example of such technique is disclosed in the following document, which will simply be referred to as “Architecture Exploration”.

“Architecture Exploration for a Reconfigurable Architecture Template”, IEEE Design & Test of Computers vol. 22, No. 2, 2005

When the control information is automatically generated by the compiler disclosed in Architecture Exploration, it is preferable that one functional block is connected to as many other functional blocks as possible and a data transmission and reception are possible, so as to assign the processes to the respective functional blocks operating according to the control information as evenly as possible.

However, when wirings for connecting the respective functional blocks increase, the chip area and power consumption of the processor also increase.

Thus, a technique has been disclosed which can dynamically switch a connection between the respective functional blocks to improve the freedom degree of transmission and reception of data between the respective functional blocks without increasing the number of wirings. An example of such technique is disclosed in international patent publication No. WO2003/009125.

However, the technique disclosed in WO2003/009125 may dynamically switch the connection between the respective functional blocks, but never considers the latency and bandwidth required in a connection between functional blocks.

For this reason, even when a connection between functional blocks in which data is transmitted and received is dynamically made, there occurs a situation in which a data transmission approaching a bandwidth is made in a wiring of one side and a small amount of data is only transmitted in a wiring of another side, and there is a problem in that hardware resources of wirings, functional blocks, and the like may not be effectively used.

### SUMMARY

According to an aspect of the invention, there is provided a processor including: a first functional block having an output data port; a second functional block having an input data port; a first connection unit that connects the output data port of the first functional block and the input data port of the second functional block; a first data converter that switches a bit width of the first connection unit to be used for a data transmission; a first controller that transmits first function control information to the first functional block and transmits second function control information to the second functional block; and a second controller that operates in synchronization with the first controller and transmits first connection control information to the first data converter, wherein the first functional block performs a first process designated by the first function control information and outputs a result of the first process from the output data port, wherein the first data converter switches a bit width of the first connection unit to be used for the data transmission to a bit width designated by the first connection control information, and wherein the second functional block performs a second process designated by the second function control information for data input from the input data port.

### BRIEF DESCRIPTION OF THE DRAWINGS

In the accompanying drawings:

FIG. 1 is a block diagram showing a configuration of a processor according to a first embodiment of the present invention;

FIGS. 2A, 2B and 2C are block diagrams showing examples of a configuration of a functional block;

FIG. 3 is a block diagram showing a configuration of a connection unit;

FIG. 4 is a block diagram showing a configuration of a transmission data converter;

FIG. 5 is a view showing a switch circuit switching example of the transmission data converter;

FIG. 6 is a view showing a switch circuit switching example of the transmission data converter;

FIG. 7 is a view showing a switch circuit switching example of the transmission data converter;

FIG. 8 is a block diagram showing a configuration of a reception data converter;

FIG. 9 is a view showing a switch circuit switching example of the reception data converter;

FIG. 10 is a view showing a switch circuit switching example of the reception data converter;

FIG. 11 is a view showing a switch circuit switching example of the reception data converter;

FIG. 12 is a block diagram showing a configuration of a data link device;

FIG. 13 is a view showing control operations of a functional block configuration controller and a connection line configuration controller;

FIG. 14 is a view showing an operation when the function block configuration control device controls selectors;

FIG. 15 is a view showing an operation when a connection line configuration controller controls a switch circuit;

FIG. 16 is a view showing functional block control information and connection line control information;

FIG. 17 is a block diagram showing a configuration “ID2=1” of the connection unit;

FIG. 18 is a block diagram showing a configuration “ID2=2” of the connection unit;

FIG. 19 is a view showing an example of the functional block control information;

FIG. 20 is a view showing the input/output relationship of commands and data to be executed in respective functional blocks;

FIG. 21 is a block diagram showing a processor without selectors;

FIG. 22 is a block diagram showing a configuration of a processor according to a second embodiment; and

FIG. 23 is a view showing functional block control information, first connection line control information, and second connection line control information.

### DETAILED DESCRIPTION OF THE EMBODIMENTS

An embodiment of the present invention will be explained with reference to the accompanying drawings.

### First Embodiment

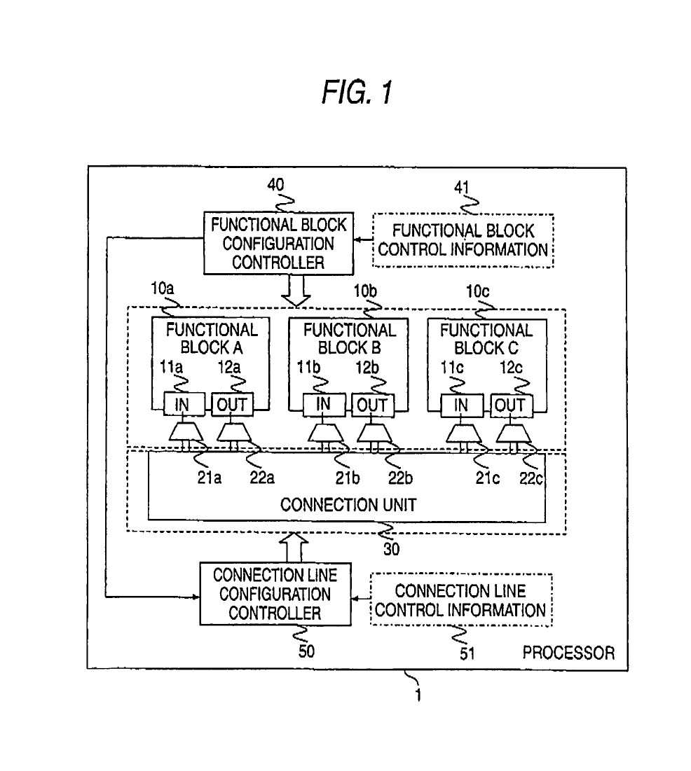

FIG. 1 is a block diagram showing a configuration of a processor 1 according to a first embodiment of the present invention.

The processor 1 according to the first embodiment includes functional blocks A10a, B10b, C10c, selectors 21a˜21c, 22a˜22c, a connection unit 30, a functional block configuration controller 40, and a connection line configuration controller 50.

The functional blocks A10a, B10b, C10c respectively have input data ports (in) 11a˜11c and output data ports (out) 12a˜12c. The input data ports (in) 11a˜11c and the output data ports (out) 12a˜12c of the functional blocks A10a, B10b, C10c are respectively connected to the selectors 21a˜21c, 22a˜22c. The respective selectors 21a˜21c, 22a˜22c are connected to the connection unit 30 by two signal lines. The respective functional blocks A10a, B10b, C10c are mutually connected via the selectors 21a˜21c, 22a˜22c and the connection unit 30.

The bit widths of the input data ports 11a˜11c and the output data ports 12a˜12c and the bit widths of signal lines connected to the input data ports 11a˜11c and the output data ports 12a˜12c are 64 bits. The bit widths of two signal lines for connecting the selectors 21a˜21c, 22a˜22c and the connection unit 30 are respectively 64 bits.

The functional block configuration controller 40 transmits control information to the functional blocks A10a, B10b, C10c and the selectors 21a˜21c, 22a˜22c according to functional block control information 41, and controls an operation thereof. The connection line configuration controller 50 transmits control information to the connection unit 30 according to connection line control information 51 and controls an operation thereof.

The functional block control information 41 and the connection line control information 51 can be stored in a storage section (not shown), and can be respectively stored in the functional block configuration controller 40 and the connection line configuration controller 50. Moreover, the functional block configuration controller 40 and the connection line configuration controller 50 can be configured in the same hardware.

The functional blocks A10a, B10b, C10c, the connection unit 30, the functional block configuration controller 40, the connection line configuration controller 50 are synchronized and operated by the same clock signal.

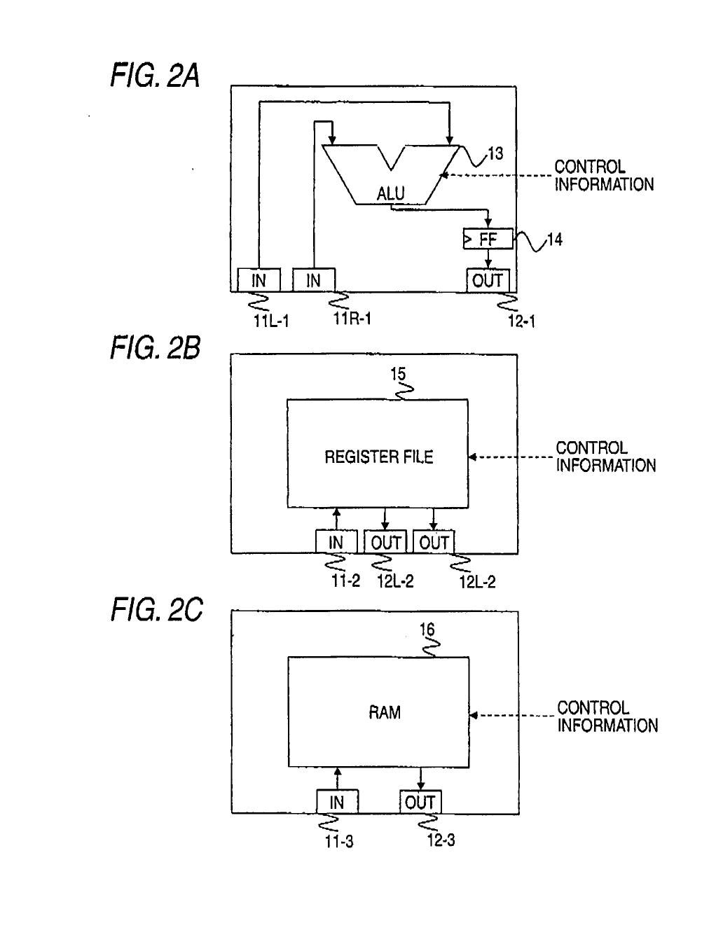

FIG. 2 is a block diagram showing a configuration example of the functional block. The functional block is not limited to the example shown in FIG. 2, and can have an input data port or an output data port and can have at least one of an ALU or register file, a RAM, a read only memory (ROM), an FF, and an external input/output (I/O).

FIG. 2A shows an example of a functional block having an arithmetic logic unit (ALU) 13, two input data ports 11L-1, 11R-1, and one output data port 12-1.

The ALU unit 13 performs arithmetic processes of addition, subtraction, and the like for data input from the two input data ports 11L-1, 11R-1 according to control information received from the functional block configuration controller 40. A type of arithmetic to be performed by the ALU 13 is designated by the control information. An arithmetic result of the ALU 13 is stored in a flip-flop (FF) 14 and is output from the output data port 12-1 after one clock has elapsed.

FIG. 2B shows an example of a functional block having a register file 15, one input data port 11-2, and two output data ports 12L-2, 12R-2.

The one input data port 11-2 is a write port of the register file 15, and the two output data ports 12L-2, 12R-2 are read ports of the register file 15. For the register file 15, two reads and one write can be simultaneously performed. The control information received from the functional block configuration controller 40 designates the presence or absence of access (read or write) for the register file 15 and an access register identification (ID) on a port basis.

FIG. 2C shows an example of a functional block having a random access memory (RAM) 16, one input data port 11-3, and one output data port 12-3.

The one input data port 11-3 is a write port of the RAM 16, and the one output data port 12-3 is a read port of the RAM 16. For the RAM 16, one read and one write can be simultaneously performed. Control information received from the functional block configuration controller 40 designates the presence or absence of access (read or write) for the RAM 16 and an access address.

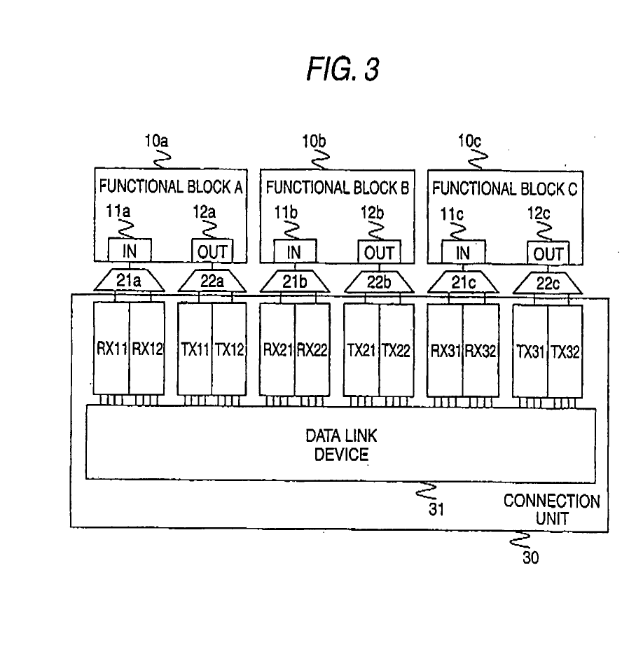

FIG. 3 is a block diagram showing a configuration of the connection unit 30.

The connection unit 30 has transmission data converters TX11˜TX32, reception data converters RX11˜RX32, and a data link device 31. The transmission data converters TX11, TX12 are connected to the selector 22a connected to the output data port 12a of the functional block A10a. The transmission data converters TX21, TX22 are connected to the selector 22b connected to the output data port 12b of the functional block B10b. The transmission data converters TX31, TX32 are connected to the selector 22c connected to the output data port 12c of the functional block C10c.

The reception data converters RX11, RX12 are connected with the selector 21a connected to the input data port 11a of the functional block A10a. The reception data converters RX21, RX22 are connected with the selector 21b connected to the input data port 11b of the functional block b10b. The reception data converters RX31, RX32 are connected with the selector 21c connected to the input data port 11c of the functional block C10c.

The transmission data converters TX11˜TX32 and the reception data converters RX11˜RX32 are connected to the data link device 31. Moreover, details of a connection of the transmission data converters TX11˜TX32 and the reception data converters RX11˜RX32 and the data link device 31 will be described below.

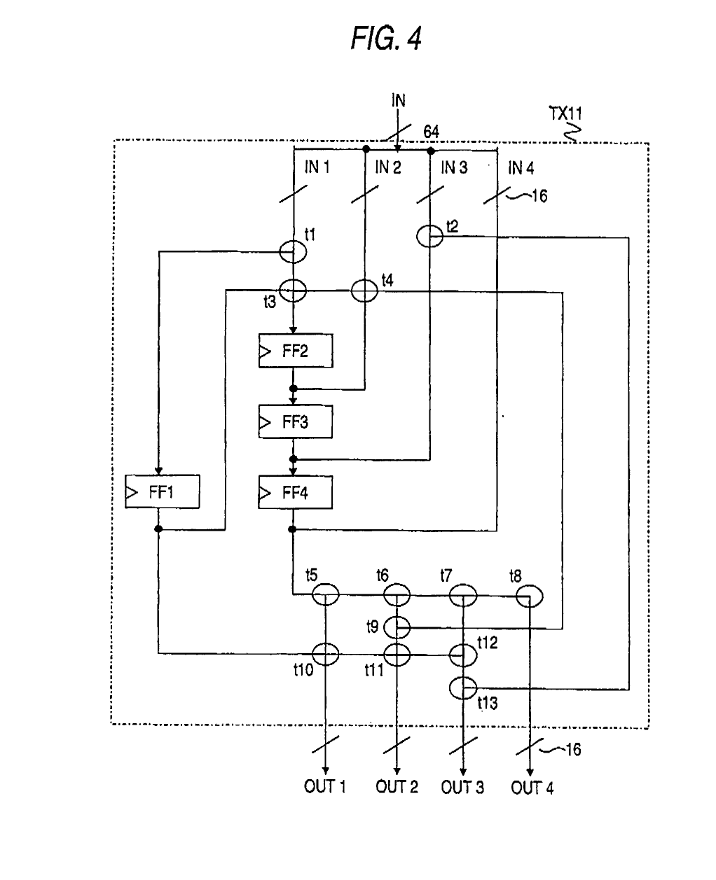

FIG. 4 is a block diagram showing a configuration of the transmission data converter TX11. Configurations of the other transmission data converters TX12˜TX32 are also identical.

The transmission data converter TX11 outputs 64-bit width data input from one 64-bit width signal line in connected with the selector 22a to four 16-bit width signal lines out1˜out4 connected with the data link device 31.

The transmission data converter TX11 includes flip-flops FF1˜FF4 and switch circuits t1˜t13. In FIG. 4, the switch circuits t1˜t13 are indicated by the circular mark surrounding a point intersecting with signal lines. The switch circuits t1˜t13 select how to connect signal lines to intersect or whether to absolutely disconnect the signal lines. The switch circuits t1˜t13 are switched according to control information transmitted via a control bus (not shown) from the connection line configuration controller 50. Moreover, the switch circuits t1˜t13 of the transmission data converters TX11˜TX32 are respectively independently controlled.

In FIG. 4, a logical OR operator is provided in a meeting point of an output from the flip-flop FF1 and an output from the switch circuit t3, a meeting point of an output from the flip-flop FF2 and an output from the switch circuit t4, a meeting point of an output from the flip-flop FF3 and an output from the switch circuit t2, and a meeting point of an output from the flip-flop FF4 and an output from the signal line in4.

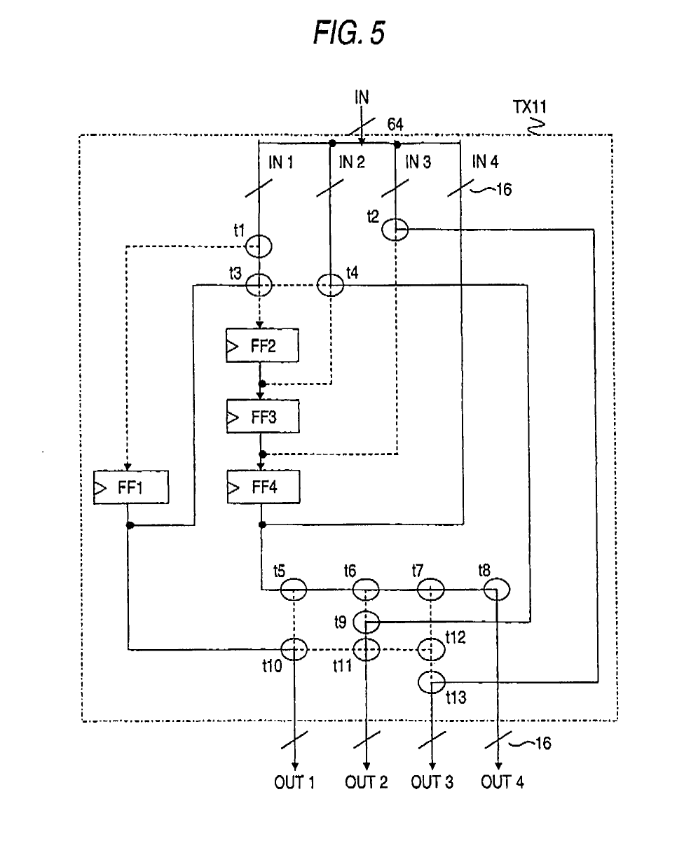

FIGS. 5 to 7 are block diagrams showing an example of switching of the respective switch circuits t1˜t13 when the transmission data converter TX11 operates. Moreover, in FIGS. 5 to 7, a wiring portion indicated by the dotted line shows that data is not transmitted.

FIG. 5 shows a switch circuit switching example when the transmission data converter TX11 outputs data input from the 64-bit width signal line in to the four 16-bit signal lines out1˜out4 in the same clock.

The 64-bit width data input from the signal line in is divided on a 16-bit basis, and is respectively transmitted to the four signal lines in1˜in4. The data transmitted to the signal line in1 is output to the signal line out1 via the switch circuits t1, t3, t10. The data transmitted to the signal line in2 is output to the signal line out2 via the switch circuits t4, t9, t11. The data transmitted to the signal line in3 is output to the signal line out3 via the switch circuits t2, t13. The data transmitted to the signal line in4 is output to the signal line out4 via the switch circuits t5, t6, t7, t8.

As the switch circuits t1˜t13 are switched as shown in FIG. 5, the transmission data converter TX11 outputs the 64-bit width input data to the four 16-bit width signal lines out1˜out4 in the same clock.

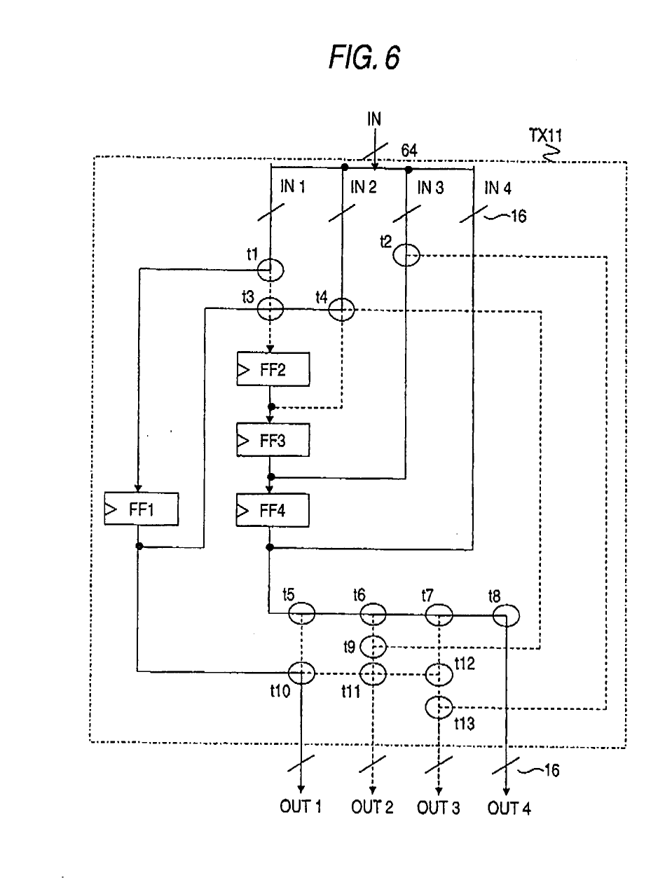

FIG. 6 shows a switch circuit switching example when the transmission data converter TX11 outputs the 64-bit width input data to two 16-bit signal lines out1, out4 in two clocks.

[First Clock]

The 64-bit width data input from the signal line in is divided on a 16-bit basis, and is respectively transmitted to the four signal lines in1˜in4.

The data transmitted to the signal line in1 is stored in the flip-flop FF1 via the switch circuit t1. The data transmitted to the signal line in3 is stored in the flip-flop FF4 via the switch circuit t2.

On the other hand, the data transmitted to the signal line in2 is output to the signal line out1 via the switch circuits t4, t3, t10. The data transmitted to the signal line in4 is output to the signal line out4 via the switch circuits t5, t6, t7, t8.

[Second Clock]

The data from the signal line in1 stored in the flip-flop FF1 is output to the signal line out1 via the switch circuit t10. The data from the signal line in3 stored in the flip-flop FF4 is output to the signal line out4 via the switch circuits t5, t6, t7, t8. Herein, by setting all outputs from the signal line in2 to “0” in the meeting point of the output from the flip-flop FF1 and the output from the signal line in2, the output of the flip-flop FF1 from the logical OR operator of the meeting point is directly output to the signal line out1. By setting all outputs from the signal line in4 to “0” also in the meeting point of the output from the flip-flop FF4 and the output from the signal line in4, the output of the flip-flop FF4 from the logical OR operator of the meeting point is directly output to the signal line out4.

As the switch circuits t1˜t13 are switched as shown in FIG. 6, the transmission data converter TX11 outputs the 64-bit width input data to two 16-bit width signal lines out1, out4 in two clocks.

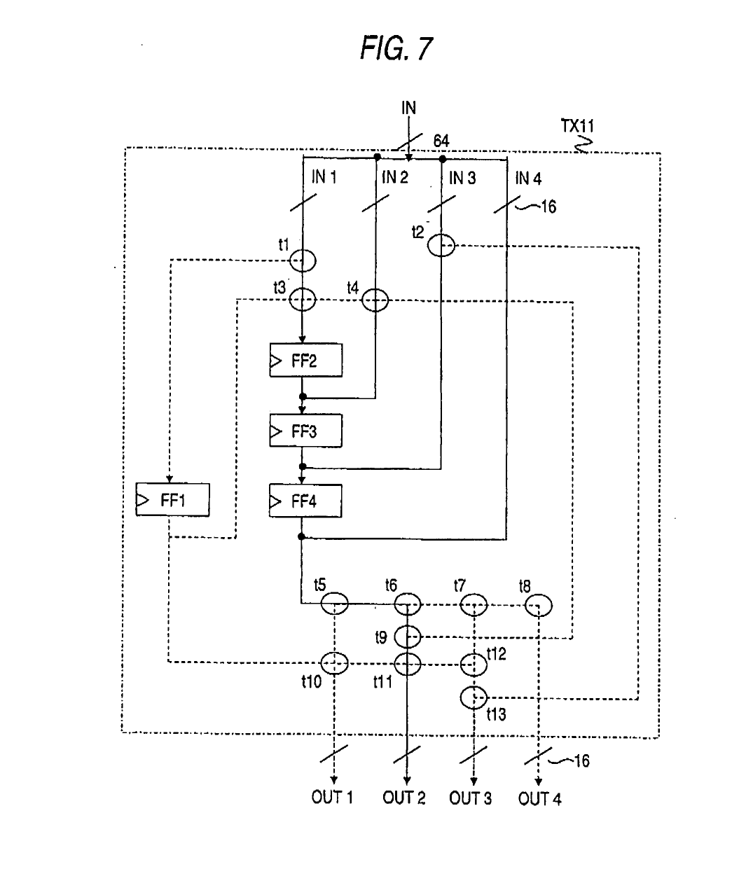

FIG. 7 shows a switch circuit switching example when the transmission data converter TX11 outputs the 64-bit width input data to one 16-bit signal line out2 in four clocks.

[First Clock]

The 64-bit width data input from the signal line in is divided on a 16-bit basis, and is respectively transmitted to the four signal lines in1˜in4.

The data transmitted to the signal line in1 is stored in the flip-flop FF2 via the switch circuits t1, t3. The data transmitted to the signal line in2 is stored in the flip-flop FF3 via the switch circuit t4. The data transmitted to the signal line in3 is stored in the flip-flop FF4 via the switch circuit t2.

On the other hand, the data transmitted to the signal line in4 is output to the signal line out2 via the switch circuits t5, t6, t9, t11.

[Second Clock]

The data from the signal line in3 stored in the flip-flop FF4 is output to the signal line out2 via the switch circuits t5, t6, t9, t11.

On the other hand, the data from the signal line in2 stored in the flip-flop FF3 is stored in the flip-flop FF4. The data from the signal line in1 stored in the flip-flop FF2 is stored in the flip-flop FF2.

Herein, by setting all outputs from the signal lines in2, in3, in4 to “0” in the meeting point of the output from the flip-flop FF2 and the output from the signal line in2, the meeting point of the output from the flip-flop FF3 and the output from the signal line in3, and the meeting point of the output from the flip-flop FF4 and the output from the signal line in4, the output of the flip-flop FF2, the output of the flip-flop FF3, and the output of the flip-flop FF4 are directly output from the logical OR operators of the respective meeting points.

[Third Clock]

The data from the signal line in2 stored in the flip-flop FF4 is output to the signal line out2 via the switch circuits t5, t6, t9, t11.

On the other hand, the data from the signal line in1 stored in the flip-flop FF3 is stored in the flip-flop FF4.

Herein, by setting all outputs of the signal lines in3, in4 to “0” in the meeting point of the output from the flip-flop FF3 and the output from the signal line in3 and the meeting point of the output from the flip-flop FF4 and the output from the signal line in4, the output from the flip-flop FF3 and the output from the flip-flop FF4 are directly output from the logical OR operators of the respective meeting points.

[Fourth Clock]

The data from the signal line in1 stored in the flip-flop FF4 is output to the signal line out2 via the switch circuits t5, t6, t9, t11.

Herein, by setting all outputs from the signal line in4 to “0” in the meeting point of the output from the flip-flop FF4 and the output from the signal line in4, the output from the flip-flop FF4 is directly output from the logical OR operator of the meeting point.

As the switch circuits t1˜t13 are switched as shown in FIG. 7, the transmission data converter TX11 outputs the 64-bit width input data to one 16-bit width signal line out2 in four clocks.

As shown above, the transmission data converters TX11˜TX32 switch the switch circuits t1˜t13 according to connection line connection information 51 received from the connection line configuration controller 50 as shown in any of FIGS. 5 to 7. Switching methods of the switch circuits of the transmission data converters TX11˜32 are not limited to those shown in FIGS. 5 to 7. Moreover, the input of the transmission data converters TX11˜TX32 is set to one 64-bit width signal line in and the output is set to four 16-bit width signal lines out1˜out4, but these are not limited thereto. For example, the input of the transmission data converters TX11˜TX32 can be set to one 64-bit width signal line in and the output can be set to 64 1-bit width signal lines out1˜out64.

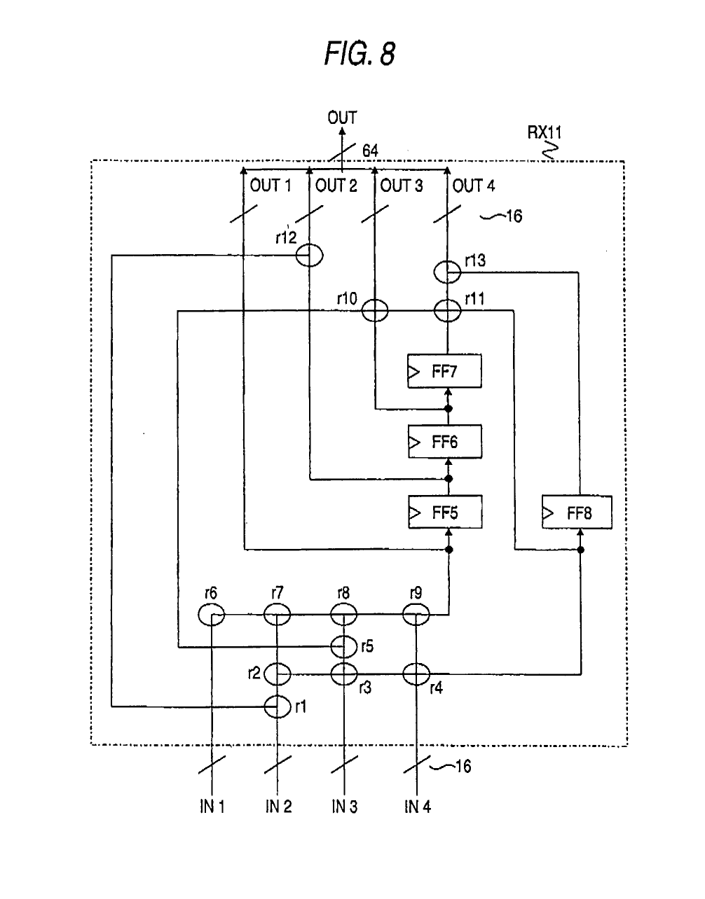

FIG. 8 is a block diagram showing a configuration of the reception data converter RX11. The configurations of the other reception data converters RX12˜RX32 are also identical.

The reception data converter RX11 outputs data input from four 16-bit width signal lines in1˜in4 connected with the data link device 31 to one 64-bit width signal line out connected with the selector 21a.

The reception data converter RX11 includes flip-flops FF5˜FF8 and switch circuits r1˜r13. In FIG. 8, the switch circuits r1˜r13 are indicated by the circular mark surrounding a point intersecting with signal lines. The switch circuits r1˜r13 can select how to connect signal lines to intersect or whether to absolutely disconnect the signal lines. The switch circuits r1˜r13 are switched according to control information transmitted via a control bus (not shown) from the connection line configuration controller 50. Moreover, the switch circuits r1˜r13 of the reception data converters RX11˜RX32 are respectively independently controlled.

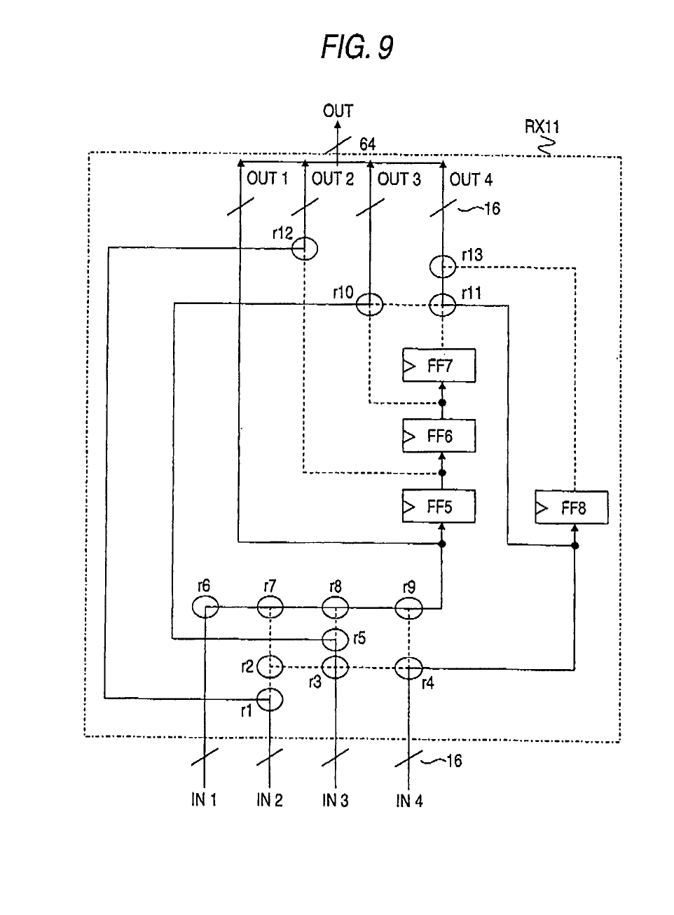

FIGS. 9 to 11 are block diagrams showing an example of switching of the respective switch circuits r1˜r13 when the reception data converter RX11 operates. Moreover, in FIGS. 9 to 11, a wiring portion indicated by the dotted line shows that data is not transmitted.

FIG. 9 shows a switching example of the switch circuits r1˜r13 when the reception data converter RX11 outputs data input from four 16-bit width signal lines in1˜in4 to one 64-bit width signal line out in the same clock.

Data input from the signal line in1 is transmitted to a signal line out1 via the switch circuits r6, r7, r8, r9. Data input from the signal line in2 is transmitted to a signal line out2 via the switch circuits r1, r12. Data input from a signal line in3 is transmitted to a signal line out3 via the switch circuits r3, r5, r10. Data input from a signal line in4 is transmitted to a signal line out4 via the switch circuits r4, r11, r13. Data transmitted to the 16-bit width signal lines out1˜out4 is combined and output from the 64-bit width signal line out.

As the switch circuits r1˜r13 are switched as shown in FIG. 9, the reception data converter RX11 outputs data input from the four 16-bit width signal line in1˜in4 to the 64-bit width signal line out in the same clock.

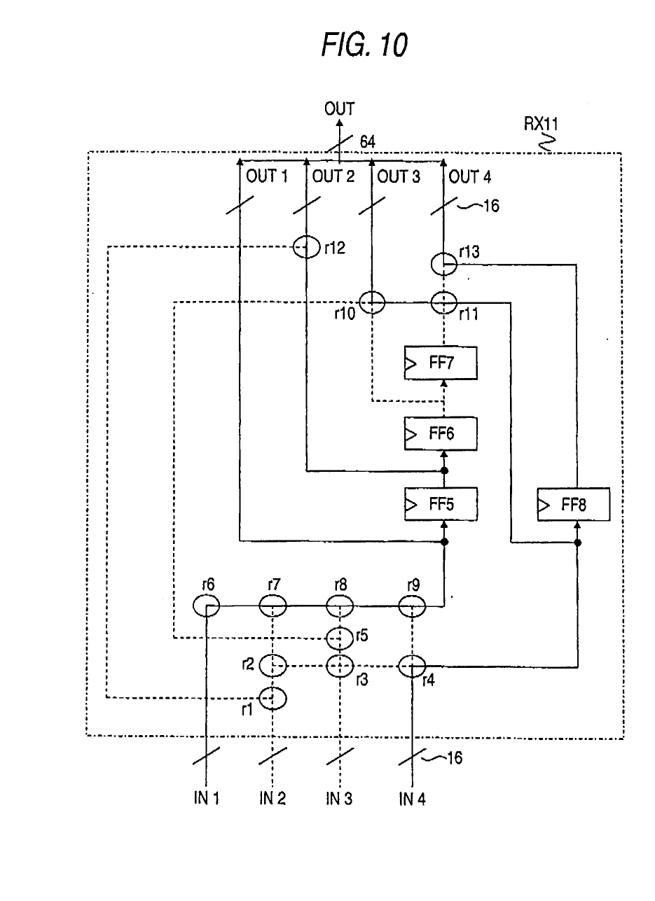

FIG. 10 shows a switching example of the switch circuits r1˜r13 when the reception data converter RX11 outputs data input from two 16-bit width signal lines in1, in4 to the 64-bit width signal line out in two clocks.

[First Clock]

First data input from the signal line in1 is stored in the flip-flop FF5 via the switch circuits r6, r7, r8, r9. Second data input from the signal line in4 is stored in the flip-flop FF8 via the switch circuit r4.

[Second Clock]

Third data input from the signal line in1 is transmitted to the signal line out1 via the switch circuits r6, r7, r8, r9. Fourth data input from the signal line in4 is transmitted to the signal line out3 via the switch circuit r4.

The first data from the signal line in1 stored in the flip-flop FF5 is transmitted to the signal line out2 via the switch circuit r12. The second data from the signal line in4 stored in the flip-flop FF8 is transmitted to the signal line out4 via the switch circuit r13.

As described above, the first to fourth data transmitted to the signal lines out1˜out4 are combined and output from the 64-bit width signal line out.

As the switch circuits r1˜r13 are switched as shown in FIG. 10, the reception data converter RX11 outputs data input from two 16-bit width signal lines in1, in4 to the 64-bit width signal line out in two clocks.

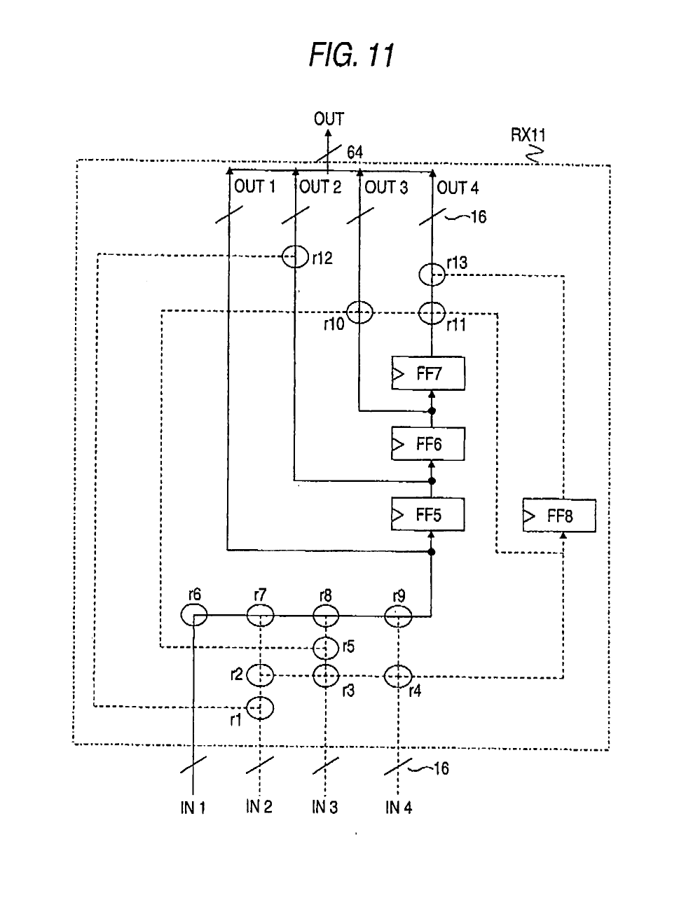

FIG. 11 shows a switching example of the switch circuits r1˜r13 when the reception data converter RX11 outputs data input from one 16-bit width signal line in1 to the 64-bit width signal line out in four clocks.

[First Clock]

First data input from the signal line in1 is stored in the flip-flop FF5 via the switch circuits r6, r7, r8, r9.

[Second Clock]

The first data from the signal line in1 stored in the flip-flop FF5 is stored in the flip-flop FF6.

Second data input from the signal line in1 is stored in the flip-flop FF5 via the switch circuits r6, r7, r8, r9.

[Third Clock]

The first data from the signal line in1 stored in the flip-flop FF6 is stored in the flip-flop FF7. The second data from the signal line in1 stored in the flip-flop FF5 is stored in the flip-flop FF6.

Third data input from the signal line in1 is stored in the flip-flop FF5 via the switch circuits r6, r7, r8, r9.

[Fourth Clock]

The first data from the signal line in1 stored in the flip-flop FF7 is transmitted to the signal line out4. The second data from the signal line in1 stored in the flip-flop FF6 is transmitted to the signal line out3. The third data from the signal line in1 stored in the flip-flop FF5 is transmitted to the signal line out2.

Fourth data input from the signal line in1 is transmitted to the signal line out1 via the switch circuits r6, r7, r8, r9.

As described above, the first to fourth data transmitted to the width signal lines out1˜out4 are combined and output from the 64-bit width signal line out.

As the switch circuits r1˜r13 are switched as shown in FIG. 11, the reception data converter RX11 outputs data input from one 16-bit width signal line in1 to the 64-bit width line out in four clocks.

As described above, the reception data converters RX11˜RX32 are switched according to connection line control information 51 received from the connection line configuration device 50 as shown in any of FIGS. 9 to 11. Moreover, switching methods of the switch circuits of the reception data converters RX11˜RX32 are not limited to those shown in FIGS. 9 to 11. Moreover, the input of the reception data converters RX11˜RX32 is set to four 16-bit width signal lines in1˜in4 and the output is set to one 64-bit width signal line out, but these are not limited thereto. For example, the input of the reception data converters RX11˜RX32 can be set to 64 1-bit width signal lines in1˜in64 and the output can be set to one 64-bit width signal line out.

Moreover, the 64-bit width data can be transmitted and received in the same clock by connecting the signal lines out1˜out4 of the transmission data converter of a switch switching state of FIG. 5 and the signal lines in1˜in4 of the reception data converter of a switch switching state of FIG. 9. Similarly, the 64-bit width data can be transmitted and received in two clocks by respectively connecting the output signal lines out1˜out4 of FIG. 6 and the input signal lines in1˜in4 of FIG. 10. The 64-bit width data can be transmitted and received in four clocks by respectively connecting the output signal lines out1˜out4 of FIG. 7 and the input signal lines in1˜in4 of FIG. 11.

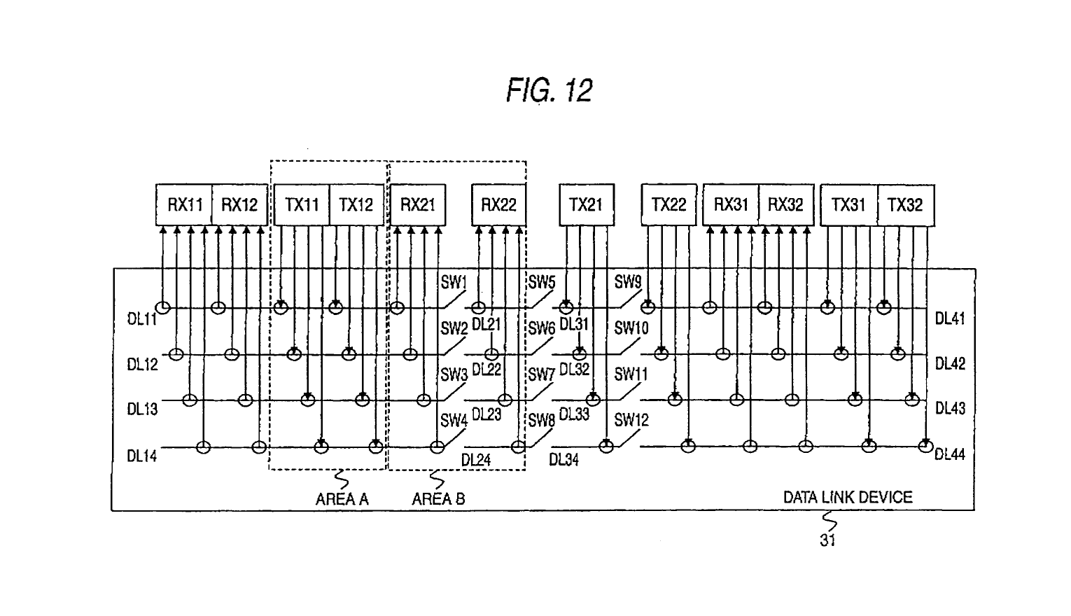

FIG. 12 is a block diagram showing a configuration of the data link device 31.

The data link device 31 includes data links DL11˜DL44, switch circuits SW1˜SW12, and a switch circuit indicated by the circular mark in FIG. 12.

The data links DL11˜DL14 are connected to the reception data converters RX11, RX12, RX21 and the transmission data converters TX11, TX12. The data links DL21˜DL24 are connected to the reception data converter RX22. The data links DL31˜DL34 are connected to the transmission data converter TX21. The data links DL41˜DL44 are connected to the reception data converters RX31, RX32 and the transmission data converters TX22, TX31, TX32.

Four arrows extending from the respective transmission data converters TX11˜TX32 to the data links are respectively 16-bit width signal lines connected to the signal lines out1˜out4 shown in FIG. 4. Four arrows extending from the data links to the respective reception data converters RX11˜RX32 are respectively 16-bit width signal lines connected to the signal lines in1˜in4 shown in FIG. 8.

A switch circuit for switching the presence or absence of a connection among the reception data converters RX11 RX32 and the transmission data converters TX11˜TX32 and the data links is indicated by the circular mark surrounding a point intersecting with the signal lines connected to the reception data converters RX11˜RX32 and the transmission data converters TX11˜TX32 and the data links in FIG. 12.

The switch circuit SW1 connects or opens a connection of the data link DL11 and the data link DL21. Similarly, SW2 connects or opens a “DL12-DL22 connection”, SW3 connects or opens a “DL13-DL23 connection”, SW4 connects or opens a “DL14-DL24 connection”, SW5 connects or opens a “DL21-DL31 connection”, SW6 connects or opens a “DL22-DL32 connection”, SW7 connects or opens a “DL23-DL33 connection”, SW8 connects or opens a “DL24-DL34 connection”, SW9 connects or opens a “DL31-DL41 connection”, SW10 connects or opens a “DL32-DL42 connection”, SW11 connects or opens a “DL33-DL43 connection”, and SW12 connects or opens a “DL34-DL44 connection”.

A switching operation of a switch circuit for switching the presence or absence of a connection among the reception data converters RX11˜RX32 and the transmission data converters TX11˜TX32 and the data links DL11˜DL44 and the switch circuits SW1˜SW12 is controlled by control information transmitted from the connection line configuration controller 50 via a control bus (not shown).

Moreover, the data links DL11˜DL44 are set to 16-bit width signal lines, but can have the same bandwidth as the output signal lines out1˜out4 of the transmission data converters TX11˜TX32 and the input signal lines in1˜in4 of the reception data converters RX11˜RX32.

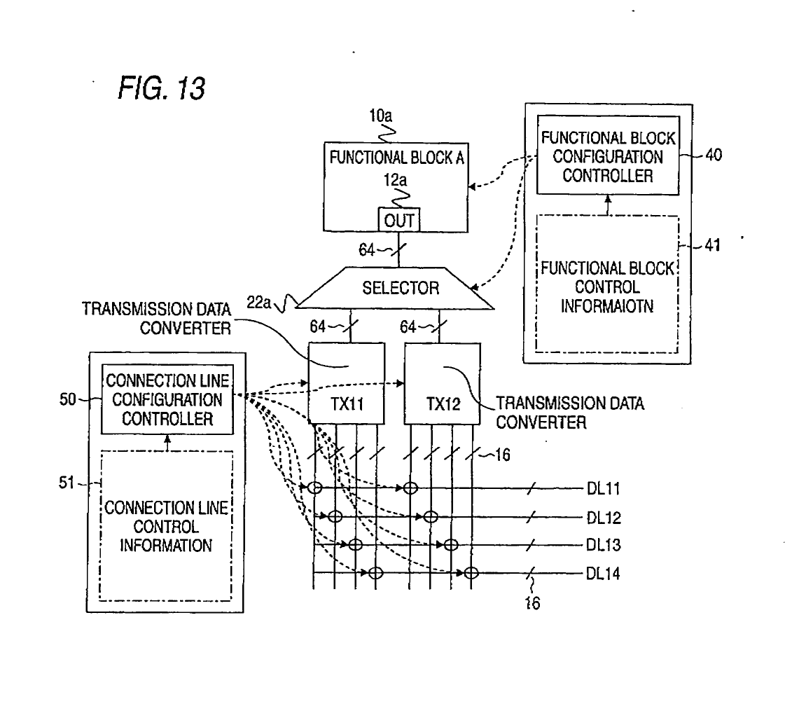

FIG. 13 is a view showing an operation of control of the functional block configuration controller 40 and the connection line configuration controller 50. Moreover, FIG. 13 shows the processor A10a, the selector 22a, and the transmission data converters TX11, TX12 and the data links DL11˜DL14 included in an area A surrounded by the dotted line of FIG. 12. Moreover, the arrow of the dotted line extending from the functional block configuration controller 40 and the connection line configuration controller 50 indicates a control bus through which a control signal is transmitted.

The functional block configuration controller 40 transmits a control signal to the functional block A10a and the selector 22a, and controls an operation thereof. The connection line configuration controller 50 transmits a control signal to the transmission data conversion means TX11, TX12 and a switch circuit for switching the presence or absence of a connection of the transmission data conversion means TX11, TX12 and the data links DL11˜DL14 via a control bus, and controls an operation thereof.

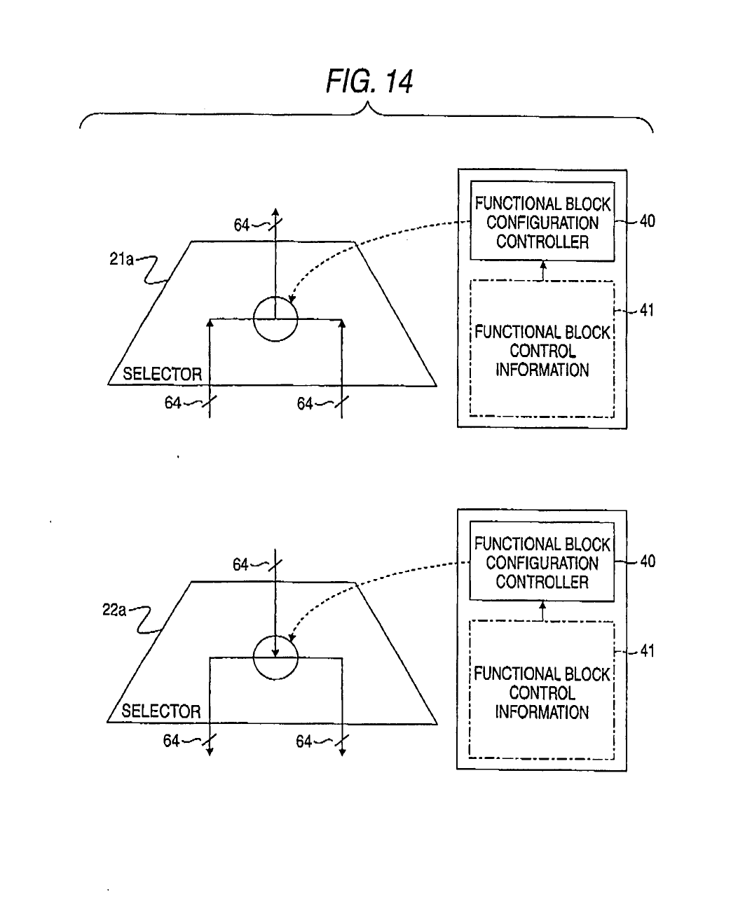

FIG. 14 is a view showing an operation when the functional block configuration controller 40 controls the selectors 21a, 22a. Moreover, the selectors 21b, 21c have the same configuration as the selector 21a, and the selectors 22b, 22c have the same configuration as the selector 22a. Moreover, the arrow of the dotted line extending from the functional block configuration controller 40 indicates a control bus through which a control signal is transmitted.

The selector 21a outputs one of two input data according to control information transmitted from the functional block configuration controller 40. The selector 22a outputs one of input data to one or both of two wirings according to control information transmitted from the functional block configuration controller 40.

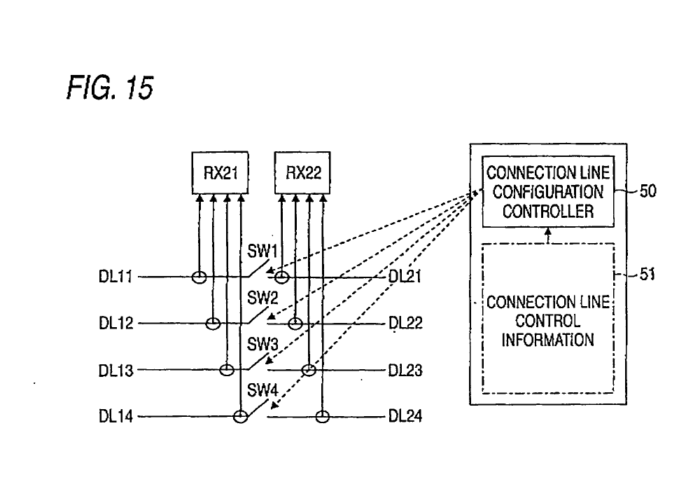

FIG. 15 is a view showing an operation when the connection line configuration controller 50 transmits control information to the switch circuits SW1˜SW4 and controls an operation thereof.

Moreover, FIG. 15 shows the reception data converters RX21, RX22, the data links DL11˜DL14, DL21˜DL24, and the switch circuits SW1˜SW4 included in an area B surrounded by the dotted line of FIG. 12. Moreover, the arrow of the dotted line extending from the connection line configuration controller 50 indicates a control bus through which a control signal is transmitted.

The connection line configuration controller 50 transmits a control signal to the switch circuits SW1˜SW4 via a control bus and controls an operation thereof.

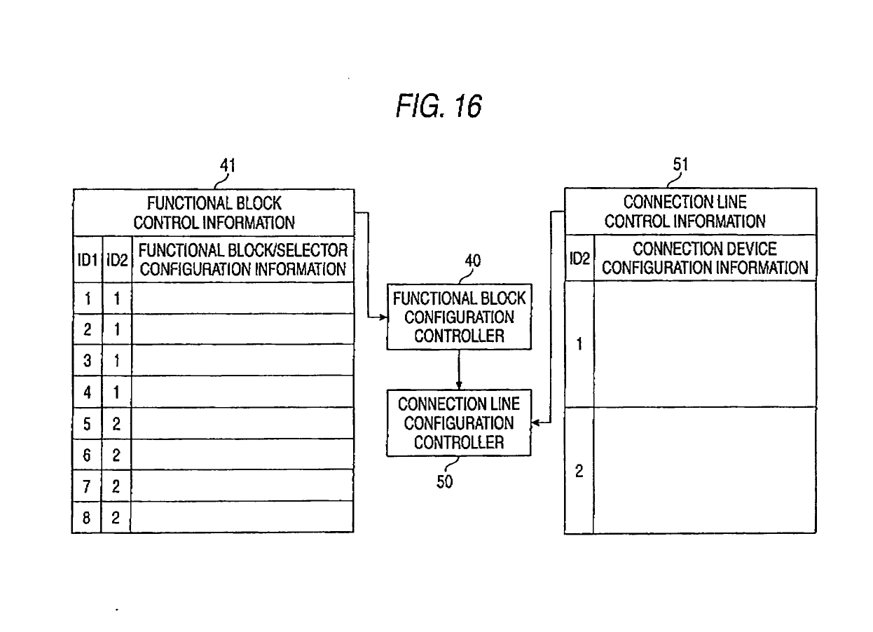

FIG. 16 is a view showing the functional block control information 41 and the connection line control information 51.

The functional block control information 41 has a plurality of entries having three information pieces of ID1, ID2, and functional block/selector configuration information. ID1 is a number assigned on an entry basis of the functional block control information 41. ID2 is a number assigned on an entry basis of the connection line control information 51. The functional block/selector configuration information is control information to be transmitted to the functional blocks A10a, B10b, C10c and the selectors 21a˜21c, 22a˜22c by the functional block configuration controller 40.

The connection line control information 51 has a plurality of entries having two information pieces of ID2 and connection unit configuration information. The connection unit configuration information is control information to be transmitted to the connection unit 30 by the connection line configuration controller 50.

The functional block configuration controller 40 reads the functional block control information 41 in one entry per clock. The functional block configuration controller 40 reads one entry of the functional block control information 41 and then transmits the functional block/selector configuration information serving as the control information to the functional blocks A10a, B10b, C10c and the selectors 21a˜21c, 22a˜22c. Moreover, the functional block configuration controller 40 transmits a value of ID2 to the connection line configuration controller 50.

The connection line configuration controller 50 receives the value of ID2 from the functional block configuration controller 40 and then selects an entry having the ID2 value. The connection line configuration controller 50 reads connection unit configuration information of the selected entry, and transmits the control information to the connection unit 30.

The functional block control information 41 and the connection line control information 51 can be compressed and stored. At this time, the functional block configuration controller 40 and the connection line configuration controller 50 have a recovery device for recovering the compressed control information.

A method of synchronizing the functional block configuration controller 40 and the connection line configuration controller 50 is not limited to synchronization in which the functional block configuration controller 40 transmits ID2 to the connection line configuration controller 50. For example, when a flag is stored in place of ID2 of the functional block control information 41 and the flag is transmitted from the functional block configuration controller 40 to the connection line configuration controller 50, the connection line configuration controller 50 can read the next entry of the connection line control information 51.

The connection line configuration controller 50 has a counter and the next entry of the connection line control information 51 can be read when its counter value reaches a certain value. Furthermore, an external processor (not shown) can switch the connection line control information 51 to the connection line configuration controller 50.

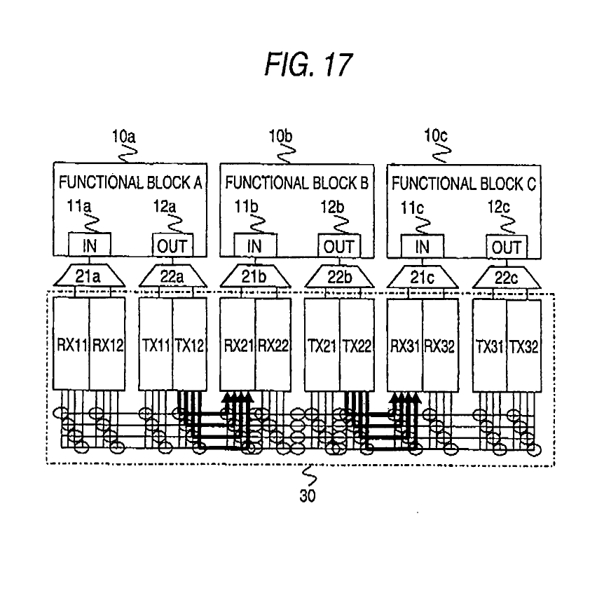

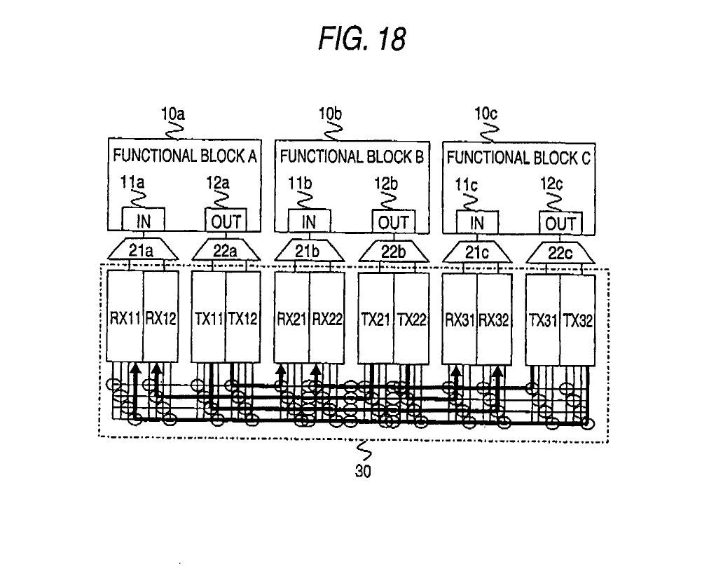

FIGS. 17 to 20 are views showing an operation when the processor 1 performs an arithmetic process. FIG. 17 is a block diagram showing a configuration of the connection unit 30 in “ID2=1”. FIG. 18 is a block diagram showing a configuration of the connection unit 30 in “ID2=2”.

In FIGS. 17 and 18, the heavy line indicates a signal line in which data is transmitted when the data is transmitted and received between functional blocks. The arrow of the heavy line indicates a direction in which the data is transmitted. In a signal line other than the heavy line, a data transmission is not performed.

In “ID2=1”, the transmission data converters TX12, TX22 switch a switch circuit as shown in FIG. 5, and the reception data converters RX21, RX31 switch a switch circuit as shown in FIG. 9. That is, data output from output data ports 12a˜12c of one functional block is input to an input data port of another functional block in the same clock as an output clock.

In “ID2=2”, the transmission data converters TX11˜TX32 switch a switch circuit as shown in FIG. 7, and the reception data converters RX11˜RX32 switch a switch circuit as shown in FIG. 11. That is, data output from an output data port of one functional block is input to an input data port of another functional block for four clocks.

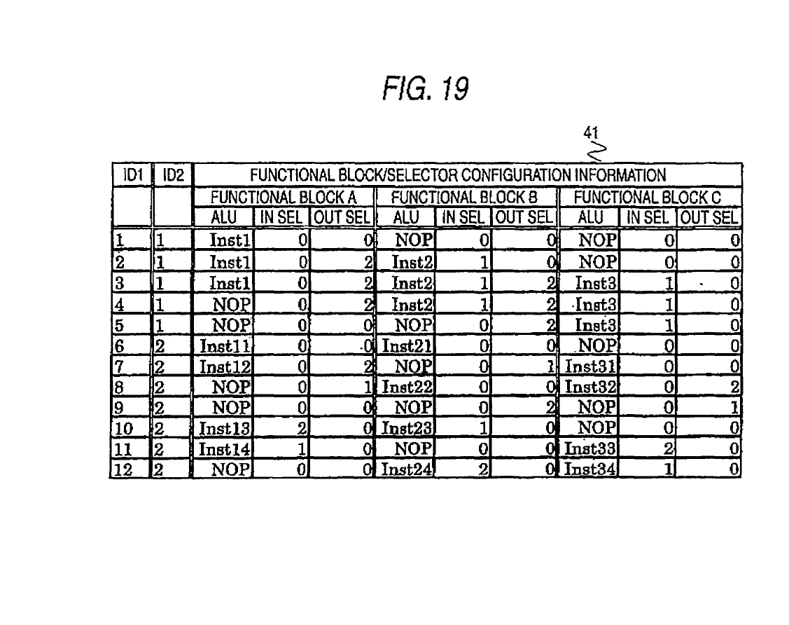

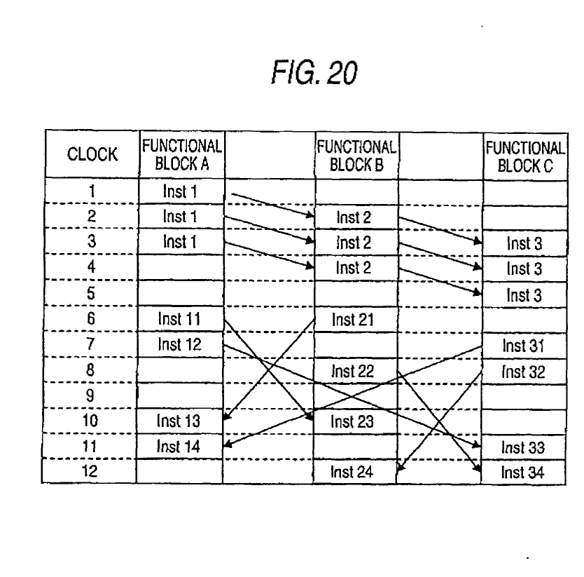

FIG. 19 is a view showing an example of the functional block control information 41 when the processor 1 performs an arithmetic process. FIG. 20 is a view showing the input/output relationship of commands and data to be executed in the respective functional blocks A10a, B10b, C10C when the processor 1 performs an arithmetic process according to the functional block control information 41 of FIG. 19.

Herein, the functional blocks A10a, B10b, C10c have an ALU (not shown). The functional block A10a can execute commands “inst1, 11˜14”, the functional block B10b can execute commands “inst2, 21˜24”, and the functional block C10c can execute commands “inst3, 31˜34”. The functional blocks A10a, B10b, C10c output an execution result of a command from the respective output data ports 12a˜12c one clock after the command is executed. The execution of the command “inst2” uses an execution result of the command “inst1”, and the execution of the command “inst3” uses an execution result of the command “inst2”. Moreover, the executions of the commands “inst23”, “inst33” “inst13”, “inst34”, “inst14”, “inst24” respectively use execution results of the commands “inst11”, “inst12” “inst21”, “inst22”, “inst31”, “inst32”.

The control information transmitted to the selectors 22a˜22c connected to the output data ports 12a˜12c of the functional blocks is described by out_sel, and the control information transmitted to the selectors 21a˜21c connected to the input data ports 11a˜11c of the functional blocks is described by in_sel.

The control information out_sel, in_sel to the selectors 21a˜21c, 22a˜22c is any value of “0”, “1”, “2”. When the control information is “0”, the selectors 21a˜21c, 22a˜22c do not input and output data.

When the control information is “1”, the selectors 21a˜21c select data from the reception data converters RX11, RX21, RX31 as inputs, and output the data to the input data ports 11a˜11c of the respective functional blocks A10a, B10b, C10c. When the control information is “1”, the selectors 22a˜22c have data from the output data ports 12a˜12c of the respective functional blocks as inputs and output the data to the transmission data converters TX11, TX21, TX31.

When the control information is “2”, the selectors 21a˜21c select data from the reception data converters RX12, RX22, RX32 as inputs, and output the data to the input data ports 11a˜11c of the respective functional blocks. When the control information is “2”, the selectors 22a˜22c have data from the output data ports 12a˜12c of the respective functional blocks as inputs and output the data to the transmission data converters TX12, TX22, TX32.

Next, an operation will be described when the functional block configuration controller 40 performs an arithmetic process according to the functional block control information 41 of FIG. 19. Moreover, the functional block configuration controller 40 is executed in order from an entry of “ID1˜1” shown in FIG. 19.

[First Clock; ID1=1, ID2=1]

The functional block configuration controller 40 reads an entry of “ID1=1” of the functional block control information 41.

Next, the functional block configuration controller 40 transmits an ID2 value “1” to the connection line configuration controller 50. When the connection line configuration device 50 receives the ID2 value “1”, the connection unit configuration information of the entry of “ID2=1” is read from the connection line configuration control information 51. The connection line configuration controller 50 controls the connection unit 30 as in the connection relationship shown in FIG. 17 according to the read connection unit configuration information. Moreover, the connection unit 30 maintains the connection relationship shown in FIG. 17 until an entry of “ID1=6” of the functional block control information 41 is executed by the functional block configuration controller 40.

Next, the functional block configuration controller 40 transmits a control signal “0” to the selectors 21a˜21c, 22a˜22c. The selectors 21a˜21c, 22a˜22c do not input and output data according to the control signal.

Next, the functional block configuration controller 40 transmits “inst1” to the functional block A10a, “No Operation (NOP)” to the functional block B10b, and “NOP” to the functional block C10c serving as control signals. According to the control signal, the functional block A10a executes “inst1” and the functional blocks B10b, C10c are set to the standby state.

[Second Clock: ID1=2, ID2=1]

Next, the functional block configuration controller 40 reads an entry of “ID1=2” of the functional block control information 41.

Next, the functional block configuration controller 40 does not transmit an ID2 value to the connection line configuration controller 50 since the ID2 value remains “1”. Consequently, the connection unit 30 maintains the connection relationship shown in FIG. 17.

Next, the functional block configuration controller 40 transmits a control signal “2” to the selector 22a, and transmits a control signal “1” to the selector 21b. The functional block configuration controller 40 transmits a control signal “0” to the other selector.

Thus, data output from the output data port 12a of the functional block A10a reaches the input data port 11b of the functional block B10b via the transmission data converter TX12, the data link device 31, the reception data converter RX21, and the selector 21b.

Herein, in the first clock, the functional block A10a starts to process a command “inst1”. Thus, in the second clock, the functional block A10a outputs a processing result of the command “inst1” from the output data port 12a. Accordingly, the processing result of the command “inst1” is input from the input data port 11b to the functional block B10b.

Next, the functional block configuration controller 40 transmits “inst1” to the functional block A10a, “inst2” to the function block B10b, and “NOP” to the functional block C10c as control signals. According to the control signal, the functional block A10a executes “inst1”, the functional block B10b executes “inst2”, and C is set to the standby state.

Hereinafter, a description of an operation of the processor 1 in third to fifth clocks is omitted.

[Sixth Clock: ID1=6, ID2=2]

Next, the functional block configuration controller 40 reads an entry of “ID1=6” of the functional block control information 41.

Next, the functional block configuration controller 40 transmits an ID2 value “2” to the connection line configuration controller 50 since the ID2 value is changed to “2”. When the connection line configuration controller 50 receives the ID2 value “2”, connection unit configuration information of an entry of “ID2=2” is read from the connection line control information 51. The connection line configuration information device 50 controls the connection unit 30 as in the connection relationship shown in FIG. 18 according to the read connection unit configuration information.

Next, the functional block configuration controller 40 transmits a control signal “0” to all the selectors 21a˜21c, 22a˜22c. Consequently, a data transmission between the functional blocks is not performed.

Next, the functional block configuration controller 40 transmits “inst11” to the functional block A10a, “inst21” to the function block B10b, and “NOP” to the functional block C10c as control signals. According to the control signal, the functional block A10a executes “inst11”, the functional block B10b executes “ins21”, and C is set to the standby state.

[Seventh Clock: ID1=7, ID2=2]

Next, the functional block configuration controller 40 reads an entry of “ID1=7” of the functional block control information 41.

Next, the functional block configuration controller 40 does not transmit an ID2 value to the connection line configuration controller 50 since the ID2 value remains “2”. Consequently, the connection unit 30 maintains the connection relationship shown in FIG. 18.

Next, the functional block configuration controller 40 transmits a control signal “2” to the selector 22a and transmits a control signal “1” to the selector 21b. The functional block configuration controller 40 transmits a control signal “0” to the other selector.

Thus, data output from the output data port 12a of the functional block A10a reaches a tenth clock to the input data port 11b of the functional block B10b for four clocks via the selector 22a, the transmission data converter TX12, the data link device 31, the reception data converter RX21, and the selector 21b.

Moreover, data output from the output data port 12b of the functional block B10b reaches the tenth clock to the input data port 11a of the functional block A10a for four clocks via the selector 22b, the transmission data converter TX21, the data link device 31, the reception data converter RX11, and the selector 21a.

Next, the functional block configuration controller 40 transmits “inst12” to the functional block A10a, “NOP” to the function block B10b, and “inst31” to the functional block C10c as control signals. According to the control signal, the functional block A10a executes “inst12”, the functional block B10b is set to the standby state, and the functional block C10c executes “inst31”.

Hereinafter, a description of an operation of the processor 1 in eighth and ninth clocks is omitted.

[Tenth Clock: ID1±10, ID2=2]

Next, the functional block configuration controller 40 reads an entry of “ID1=10” of the functional block control information 41.

Next, since the ID2 value remains “2”, the functional block configuration controller 40 does not transmit the ID2 value to the connection line configuration controller 50. Consequently, the connection unit 30 maintains the connection relationship shown in FIG. 18.

Next, the functional block configuration controller 40 transmits a control signal “2” to the selector 21a and transmits a control signal “1” to the selector 21b. The functional block configuration controller 40 transmits a control signal “0” to the other selector.

Thus, data from the reception data converter RX12 is input to the input data port 11a of the functional block A10a. Data from the reception data converter RX21 is input to the input data port 11b of the functional block B10b.

Herein, a processing result of the command “inst11” executed in the sixth clock by the functional block A10a reaches the input data port 11b of the functional block B10b for four clocks and is input thereto. Moreover, a processing result of the command “inst21” executed in the sixth clock by the functional block B10b reaches the input data port 11a of the functional block A10a for four clocks and is input thereto.

Next, the functional block configuration controller 40 transmits “inst13” to the functional block A10a, “inst23” to the function block B10b, and “NOP” to the functional block C10c as control signals. According to the control signal, the functional block A10a executes “inst13”, the functional block B10b executes “inst23”, and C is set to the standby state.

Hereinafter, a description of an operation of the processor 1 in eleventh and twelfth clocks is omitted.

FIG. 20 is a view showing the input/output relationship of commands and data to be executed in the respective functional blocks A10a, B10b, C10c when the processor 1 performs an arithmetic process according to the functional block control information 41 of FIG. 19.

The commands assigned to the functional blocks A10a, B10b, C10c are described in correspondence with the first to twelfth clocks. This is the same as the functional block control information 41 shown in FIG. 19.

[First to Fifth Clocks]

“The arrow from the functional block A10a of a clock 1 to the functional block B10b of a clock 2” is described. The functional block A10a executes a command “inst1” in the clock 1. Thus, in the clock 2, there is shown that a processing result is transferred from the functional block A10a to the functional block B10b.

This is identical also in terms of the arrows in an area from the clock 1 to a clock 5, for example, “the arrow from the functional block A10a of the clock 2 to the functional block B10b of a clock 3” and “the arrow from the functional block B10b of a clock 4 to the functional block C10c of the clock 5.

[Sixth to Twelfth Clocks]

“The arrow from the functional block A10a of a clock 6 to the functional block B10b of a clock 10” is described. The functional block A10a executes a command “inst11” in the clock 6. Thus, for four clocks from a clock 7 to the clock 10, there is shown that the functional block A10a transmits a processing result to the functional block B10b.

This can also be said for the arrows in an area from the clock 6 to a clock 12, for example, “the arrow from the functional block A10a of the clock 7 to the functional block C10c of a clock 11” and “the arrow from the functional block C10c of the clock 7 to the functional block A10a of the clock 11”.

“ID2=1” in the first to fifth clocks, and the bandwidth of a wiring connected between the functional block A10a and the functional block B10b and between the functional block B10b and the functional block C10c is large. However, a data transmission other than between the functional block A10a and the functional block B10b and between the functional block B10b and the functional block C10c is not performed.

The data transmission in the first to fifth clocks is only performed from the functional block A10a to the functional block B10b or from the functional block B10b to the functional block C10c. However, using an execution result of the command “inst1” of the functional block A10a, the functional block B10b executes the command “inst2”. Moreover, using an execution result of the command “inst2” of the functional block B10b, the functional block C10c executes the command “inst3”. The method in which the bandwidth of a wiring connected between the respective functional blocks A10a, B10b, C10c is large and a data transmission is quickly made can shorten a period of time in which the functional block B10b and the functional block C10c are set to the atmospheric state. Consequently, the processing efficiency of the entire processor 1 is improved.

On the other hand, in the sixth to twelfth clocks, “ID2=2”, and the respective functional blocks A10a, B10b, C10c can perform a data transmission to another arbitrary functional block. However, the bandwidth of the wiring connected between the respective functional blocks A10a, B10b, C10c is small.

In the sixth to twelfth clocks, a data transmission widely ranges from the functional block A10a to the functional blocks B10b, C10c, from the functional block B10b to the functional blocks C10c, A10a, and from the functional block C10c to the functional blocks A10a, B10b. In this situation, it is necessary to increase a degree of freedom when selecting opposite parties to which the respective functional blocks can directly transmit data rather than to increase a bandwidth between specific functional blocks.

As described above, the processor 1 according to the first embodiment automatically changes not only the connection relationship of the respective functional blocks, but also the bandwidth of the wiring between the respective functional blocks in a smaller unit than the width of the input/output data port of the respective functional blocks. Consequently, a method of distributing wiring resources can be automatically changed according to properties of an application to be executed in the processor, and the data transmission between the respective functional blocks can be efficiently performed. By improving the data transmission efficiency between the respective functional blocks, the processing efficiency can also be improved and hardware resources provided in the processor can be effectively used. Therefore, the chip area of the processor can be reduced and the power consumption can be suppressed.

The embodiment adopts the functional block configuration controller 40 for performing control of the respective functional blocks A10a, B10b, C10c and the connection line configuration controller 50 for performing control of the connection unit 30 in different hardware configurations. A high processing rate is achieved in the functional block configuration controller 40 for controlling processes of the respective functional blocks A10a, B10b, C10c on a clock cycle basis. On the other hand, there is no problem even when a processing rate is low in the connection line configuration controller 50 for changing the connection relationship of the connection unit 30 on a relatively long period basis of switching of an application to be executed. Consequently, a configuration based on the required processing capability can be made by realizing the functional block configuration controller 40 and the connection line configuration controller 50 with different hardware.

The processor 1 according to the first embodiment includes the selectors 21a˜21c, 22a˜22c between the input/output data ports 11a˜12c of the respective functional blocks and the connection unit 30. The functional block configuration controller 40 transmits a control signal to the respective functional blocks A10a, B10b, C10c and the selectors 21a˜21c, 22a˜22c connected thereto. On the other hand, the connection line configuration controller 50 transmits a control signal to a large number of switch circuits provided in the connection unit 30. Consequently, the consumption power when the connection line configuration controller 50 operates is higher than the consumption power when the functional block configuration controller 40 operates. As the functional block configuration controller 40 controls the selectors 21a˜21c, 22a˜22c and the connection relationship is configured to be changeable, the number of operations of the connection line configuration controller 50 can be reduced and the consumption power can be reduced.

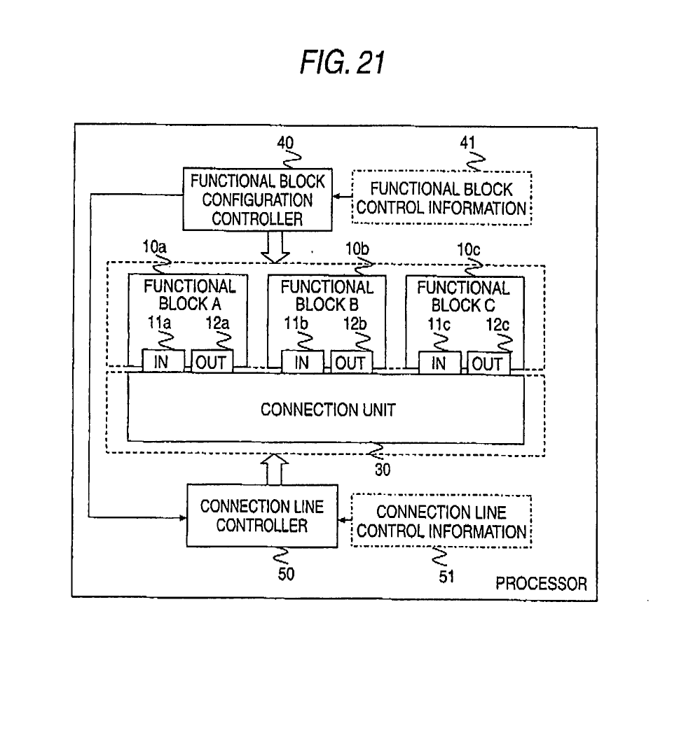

The processor 1 according to the first embodiment can be configured without the selectors 21a˜21c, 22a˜22c. FIG. 21 is a block diagram showing a processor without the selectors 21a˜21c, 22a˜22c. In this configuration, a chip area occupied by the selectors 21a˜21c, 22a˜22c and wirings connected thereto can be reduced.

### Second Embodiment

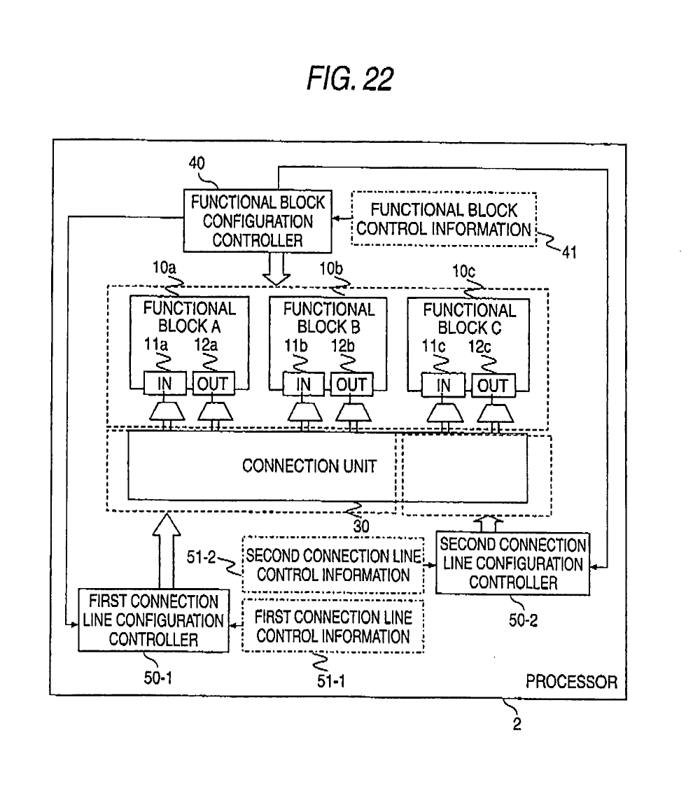

FIG. 22 is a block diagram showing a configuration of a processor 2 according to a second embodiment of the present invention.

The processor 2 according to the second embodiment includes functional blocks A10a, B10b, C10c, selectors 21a˜21c, 22a˜22c, a functional block configuration controller 40, a first connection line configuration controller 50-1, and a second connection line configuration controller 50-2. Since the functional blocks A10a, B10b, C10c, the selectors 21a˜21c, 22a˜22c, and the functional block configuration controller 40 are the same as those of the first embodiment, the same reference numerals are assigned and a description thereof is omitted.

The first connection line configuration controller 50-1 controls the connection unit 30 according to first connection line control information 51-1. The second connection line configuration controller 50-2 controls the connection unit 30 according to second connection line control information 51-2.

That is, the connection line configuration controller 50 of the first embodiment is configured with the first connection line configuration controller 50-1 and the second connection line configuration controller 50-2, which is different in comparison with the first embodiment.

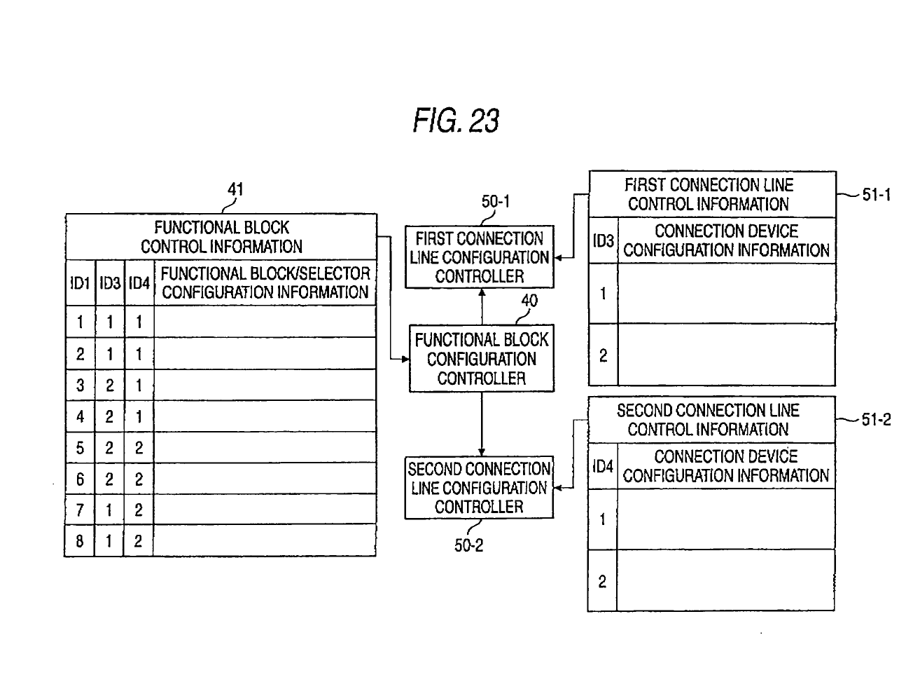

FIG. 23 is a view showing functional block control information 41 and the first and second connection line control information 51-1, 51-2.

The functional block control information 41 has a plurality of entries having four information pieces of ID1, ID3, ID4 and functional block/selector configuration information. ID1 is a number assigned on an entry basis of the functional block control information 41. ID3 is a number assigned on an entry basis of the first connection line control information 51-1. ID4 is a number assigned on an entry basis of the second connection line control information 51-2. The functional block/selector configuration information is control information to be transmitted to the functional blocks A10a, B10b, C10c and the selectors 21a˜21c, 22a˜22c by the functional block configuration controller 40.

The first connection line control information 51-1 has a plurality of entries having two information pieces of ID3 and connection unit configuration information. The connection unit configuration information is control information to be transmitted to the connection unit 30 by the first connection line configuration controller.

The second connection line control information 51-2 has a plurality of entries having two information pieces of ID4 and connection unit configuration information. The connection unit configuration information is control information to be transmitted to the connection unit 30 by the second connection line configuration controller 50-2.

The functional block configuration controller 40 reads the functional block control information 41 in one entry per clock. The functional block configuration controller 40 reads one entry of the functional block control information 41 and then transmits the functional block/selector configuration information serving as the control information to the functional blocks A10a, B10b, C10c and the selectors 21a˜21c, 22a˜22c. Moreover, the functional block configuration controller 40 transmits a value of ID3 to the first connection line configuration controller 50-1 and a value of ID4 to the second connection line configuration controller 50-2.

The first connection line configuration controller 50-1 receives the value of ID3 from the functional block configuration controller 40 and then selects an entry having the ID3 value. The first connection line configuration controller 50-1 reads connection unit configuration information of the selected entry, and transmits the control information to the connection unit 30.

The second connection line configuration controller 50-2 receives the value of ID4 from the functional block configuration controller 40 and then selects an entry having the ID4 value. The second connection line configuration controller 50-2 reads connection unit configuration information of the selected entry, and transmits the control information to the connection unit 30.

In the processor 1 according to the second embodiment as described above, the connection line configuration controller 50 for controlling the connection unit 30 is configured by two separate hardware devices. Consequently, for example, when an operation frequency of the connection unit 30 controlled by the first control line control device 50-1 is high and an operation frequency of the connection unit 30 controlled by the second control line control device 50-2 is low, the first control line control device 50-1 and the second control line control device 50-2 can be independently operated and the consumption power can reduced. Moreover, since the connection unit 30 is controlled by two information pieces of the first control line connection information 51-1 and the second control line connection information 51-2, the complex control of the connection unit 30 can be realized even when the number of entries of one or both of the control line connection information pieces is small.

It is to be understood that the invention is not limited to the specific embodiment described above and that the present invention can be embodied with the components modified without departing from the spirit and scope of the present invention. The present invention can be embodied in various forms according to appropriate combinations of the components disclosed in the embodiments described above. For example, some components may be deleted from all components shown in the embodiments. Further, the components in different embodiments may be used appropriately in combination.

What is claimed is:

1. A processor comprising:
a first functional block having an output data port;
a second functional block having an input data port;
a first connection unit that connects the output data port of the first functional block and the input data port of the second functional block;
a first data converter that switches a bit width of the first connection unit to be used for a data transmission;
a first controller that transmits first function control information to the first functional block and transmits second function control information to the second functional block; and
a second controller that operates in synchronization with the first controller and transmits first connection control information to the first data converter,
wherein the first functional block performs a first process designated by the first function control information and outputs a result of the first process from the output data port,
wherein the first data converter switches the bit width of the first connection unit to be used for the data transmission to a bit width designated by the first connection control information, and
wherein the second functional block performs a second process designated by the second function control information for data input from the input data port.

2. The processor according to claim 1, wherein the first connection unit includes N signal lines, where N is an integer larger than 1, and
wherein the first data converter switches the number of signal lines to be used for the data transmission.

3. The processor according to claim 1, wherein the first controller and the second controller are configured by separate hardware devices.

4. The processor according to claim 3 further comprising:
a third functional block having an output data port;
a second connection unit that connects the output data port of the third functional block and the input data port of the second functional block; and
a first selector that selects data to be output to the input data port of the second functional block from among (1) data received from the output data port of the first functional block through the first connection unit and (2) data received from the output data port of the third functional block through the second connection unit,
wherein the first controller transmits first selection control information to the first selector, and
wherein the first selector performs the selection based on the first selection control information.

5. The processor according to claim 3 further comprising:
a third functional block having an input data port;
a third connection unit that connects the output data port of the first functional block and the input data port of the third functional block; and
a second selector that selects transmission target of data output from the output data port of the first functional block from among (1) input data port of the second functional block through the first connection unit and (2) input data port of the third functional block through the third connection unit,
wherein the first controller transmits second selection control information to the second selector, and
the second selector performs selection based on the second selection control information.

6. The processor device according to claim 3 further comprising:
a third functional block having an output data port;
a fourth functional block having an input data port;
a fourth connection unit that connects the output data port of the third functional block and the input data port of the fourth functional block;
a second data converter that switches a bit width of the fourth connection unit to be used for a data transmission; and
a third controller that transmits second connection control information to the second data converter,
wherein the first controller transmits third function control information to the third functional block and transmits fourth function control information to the fourth functional block,
wherein the third functional block performs a third process designated by the third function control information and outputs a result of the third process from the output data port,
wherein the second data converter switches the bit width of the fourth connection unit to be used for a data transmission to a bit width designated by the second connection control information,
wherein the fourth functional block performs a forth process designated by the fourth function control information for data input from the input data port, and
wherein the second controller and the third controller are configured by separate hardware devices.
